(19) United States
(12) Patent Application Publication
(10) Pub. No.: US 2003/0188576 A1
(43) Pub. Date: Oct. 9, 2003

(54) Engine oil auto-add system

(76) Inventor: Gile Jun Yang Park, Burnaby (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/114,947

(22) Filed: Apr. 4, 2002

(51) Int. Cl. G01F 23/30

(52) U.S. Cl. 73/307; 73/313; 340/623

(57) ABSTRACT

This invention relates to a novel engine oil system which automatically or manually replenishes oil in the crankcase from an onboard oil reservoir system. An oil level indicator and oil refill device comprising: (a) a source of electrical power; (b) an engine crankcase; (c) an oil level float in the crankcase; (d) a first electrical contact point associated with the oil level float; (e) a second electrical contact point located at a predetermined level in the crankcase; (f) an oil reservoir; and (g) an electrical solenoid valve connected to the source of electrical power and the oil reservoir and normally in a closed position, the solenoid valve being activated when the first electrical contact point contacts the second electrical contact point and opening the solenoid valve and permitting oil to drain from the oil reservoir to the crankcase, said solenoid valve closing when the first electrical contact point rises with oil level and ceases to contact the second electrical contact point.

### TECHNICAL FIELD

This invention relates to a novel engine oil system which automatically or manually replenishes oil in the crankcase from an onboard oil reservoir system.

### BACKGROUND

For many years, it has been common practice for automobile owners, mechanics and service station operators to check the oil level in the crankcase of an automobile engine by withdrawing a dip-stick that penetrates into the oil in the crankcase. The dipstick is usually marked with a line that indicates when oil should be added to the crank-case. The level of the oil is shown as a liquid mark on the dipstick. If the mark is below the “Add Oil” line, oil is added to the crankcase through an add-oil pipe.

A number of devices have been invented over the years to replace the common dipstick.

U.S. Pat. No. 1,515,524, Smith, issued Nov. 11, 1924, discloses an oil gauge for use with an automobile. The gauge is simple in construction, certain in operation and visible from the driver's seat. The liquid level indicator has a chamber with a float therein supporting an indicator and means establishing communication between the chamber and the liquid to be measured.

U.S. Pat. No. 1,837,240, Thomas et al., issued Dec. 22, 1931, disclosed an oil gauge which takes the place of the measuring stick and can be readily inserted and removed in the opening usually provided in the crankcase for the measuring stick. The gauge consists of a tube of uniform outside diameter, which is adapted to extend downwardly into the engine crankcase. An indicator tube, somewhat larger in outside diameter than the tube, is positioned on the top of the tube.

U.S. Pat. No, 3,983,752, Holt, issued Oct. 5, 1976, discloses an oil level gauge for vehicles, such as tractor-scrapers, which have an oil reservoir in a relatively inaccessible location. An upright tube of small diameter has an open lower end below the lowest level of oil in the reservoir, and an upper end which is in a location that is readily viewed by a person checking the oil level. A gauge rod in the tube has a float at its lower end and has a bright colored enlargement at its upper end which is visible through a sight glass in a fitting that surmounts and seals the top of the tube. The float and the enlargement serve to guide the rod.

U.S. Pat. No. 4,034,608, Vincent, issued Jul. 12, 1977, discloses a device designed to replace the conventional automotive dipstick wherein the level of oil in an automotive crankcase is continually monitored by means of a direct readout on a visual gauge mounted on a vehicle dashboard or other convenient location within the automotive passenger compartment. The device consists of a length of cylindrical tubing threadably adjustable within a cap to predetermine its overall length as required by the specific oil reservoir, a float mechanism attached to the bottom end of the cylinder tubing, with the float being mechanically and electrically connected to a float resistor. The float lowers as the oil in the crankcase is depleted so as to register a corresponding reading on the visual gauge in the automotive passenger compartment.

### SUMMARY OF THE INVENTION

The device according to the invention is designed to replace the conventional engine oil dipstick, and to provide an on-board system that can be used to replenish oil in the crankcase. With the subject invention, the level of oil in an engine crankcase is continually monitored on the dashboard by means of a direct readout of a visual red light which means “add”, a green light which means “full”, and an optional push button switch which activates a solenoid valve which enables oil to be added to the engine crankcase. The device readout is mounted on a vehicle dashboard or other convenient location within the automotive passenger compartment. The device comprises a float switch assembly which functions both mechanically and electrically. When the oil level in the crankcase is low, the float descends and contacts an electric contact point which activates a red light. With the manual system, the red light provides a signal to the driver/operator to add engine oil to the crankcase to bring the oil level up to the proper level. With the automatic system, oil is added when the float contacts the electric contact point. Preferably, this is done when the vehicle is parked on level ground.

The invention is directed to an oil level indicator and oil refill device comprising: (a) a source of electrical power; (b) an engine crankcase; (c) an oil level float in the crankcase; (d) an upper electrical contact point; (e) a lower electrical contact point; (f) an oil reservoir; (g) an electric solenoid valve connected to the source of electrical power and the oil reservoir; and (h) a control button which is connected to the solenoid valve and when activated opens the solenoid valve and permits oil to drain from the oil reservoir to the crankcase.

The float in an upper position can cause a movable contact point to contact an upper stationary contact point to permit electrical current from the source of electrical power to activate a green light. The float in a lower position can cause a movable contact point to contact a lower stationary contact point to permit electrical current from the source of electrical power to activate a red light. The movable upper and lower contact points can be connected to the source of electrical power by an ignition switch.

The float can be constructed of a housing which can be open to oil level in the crankcase and an oil float within the housing that can ride at the level of the oil in the crankcase.

The oil reservoir can be equipped with an air cleaner and can be marked with markings to indicate the amount of oil that should be added to the crankcase to bring the level of oil in the crankcase to a predetermined level of oil.

The control button when depressed, can contact a terminal which can enable electrical current to pass from the source of electrical power to the solenoid valve and open the solenoid valve.

### BRIEF DESCRIPTION OF DRAWINGS

In drawings which illustrate specific embodiments of the invention, but which should not be construed as restricting the spirit or scope of the invention in any way:

FIG. 1 illustrates a schematic of the oil level monitor, onboard oil refill tank and oil level signal lights, when oil level is low.

FIG. 2 illustrates a schematic of the oil level monitor, onboard oil refill tank and oil level signal lights, when oil level is up to acceptable level.

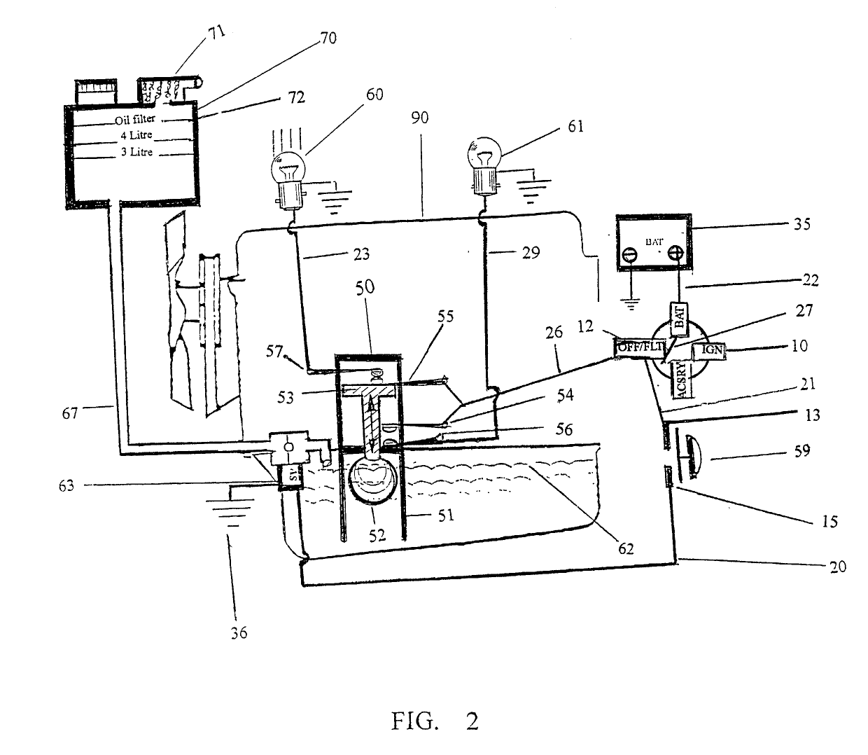

FIG. 3 illustrates a schematic of the oil level monitor, onboard oil refill tank and automatic refill when oil level is low.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

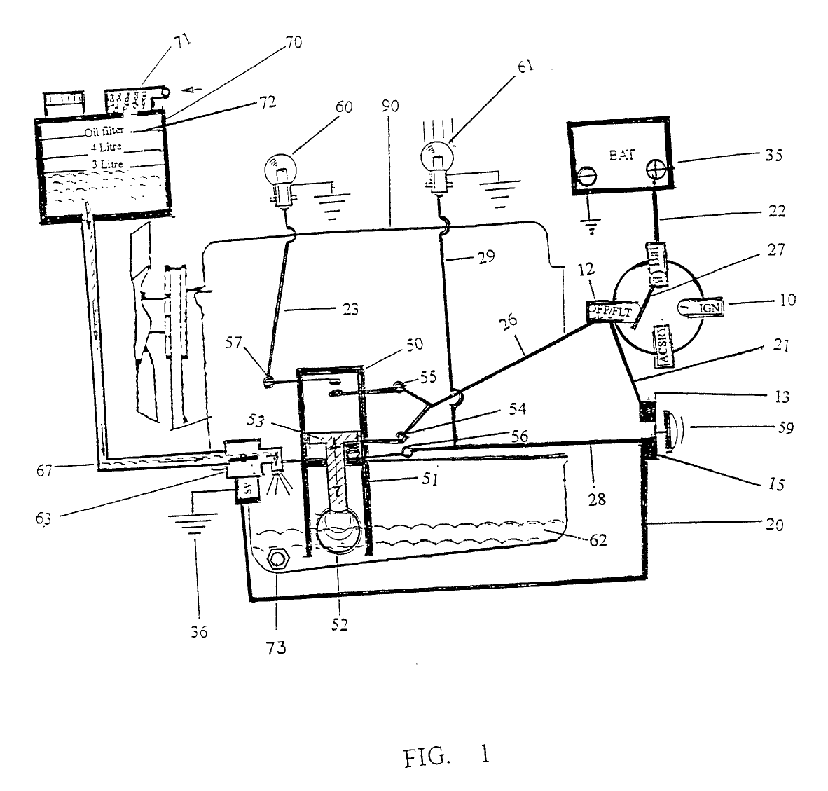

Referring to the drawings, FIG. 1 illustrates a schematic of the oil level monitor, on-board oil refill tank and oil level signal lights, when oil level is low. As seen in FIG. 1, the battery 35 provides and electric current through wire 22 to ignition switch 10. The ignition switch 10 is electrically connected into off/float terminal 12 through electric contact 27, and via wire 26 to two electrical contact points 54, 55 in a float switch assembly 50, which is located in the crankcase 62. The float assembly 50 comprises an inverted cup 51 which is mounted in association with the crankcase 62 and at its bottom end is immersed in the oil in the crankcase 62 of the engine 90. A float 52 with a top plate 53 is positioned inside the float assembly 50. When the engine oil is low, the float 52 descends and the top plate 53 contacts and moves the lower electric contact point 54 downwardly so that it contacts lower stationary contact point 56. Then, electric current passes through the wire 29 and activates red light 61, which gives notice to operator/driver to add engine oil.

Typically, the operator/driver is first seated in the automobile and looks at the dashboard prior to starting the engine 90. If the operator/driver sees the red light 61 lit up, the operator/driver pushes the push button 59 which contacts push button electric terminals 13, 15. This enables the electric current to pass through wire 21 from off/float terminal 12 in the ignition switch 10 through the push button switch 59 and then through electric wire 20 to the solenoid valve 63. The solenoid valve 63 is normally closed. However, when the solenoid valve 63 is activated by the push button switch 59, it opens and engine oil from engine oil reservoir 70 flows down through oil hose 67, through the solenoid valve 63 and into the crankcase 62 of the engine 90. As the level of engine oil builds up, the float 52 ascends so that the plate 53 contacts the upper movable electric contact point 55 and raises it so that it contacts upper stationary contact point 57. Electric current then passes through the wire 23 and activates green light 60. This signals to the operator/driver that the engine crankcase has a proper level of oil and the operator/driver releases push button 59.

The engine oil reservoir 70 has an air cleaner 71 which permits only clean air to enter engine oil reservoir 70. The oil filter level 72 indicates to whoever wishes to change the engine oil, such as a mechanic, to fill the reservoir 70 with engine oil up to oil filter mark 72. He or she then replaces the oil filter and drains crankcase 62 of engine oil. When the oil is emptied, the mechanic tightens the plug 73 and pushes the push button 59. This causes the solenoid valve 63 to open so that oil from the engine oil reservoir 70 passes down through the hose 67, through solenoid valve 63 and to the engine crankcase 62. When the crankcase 62 is full, the float 52 rises and green light 60 lights up indicating that the crankcase 62 is full.

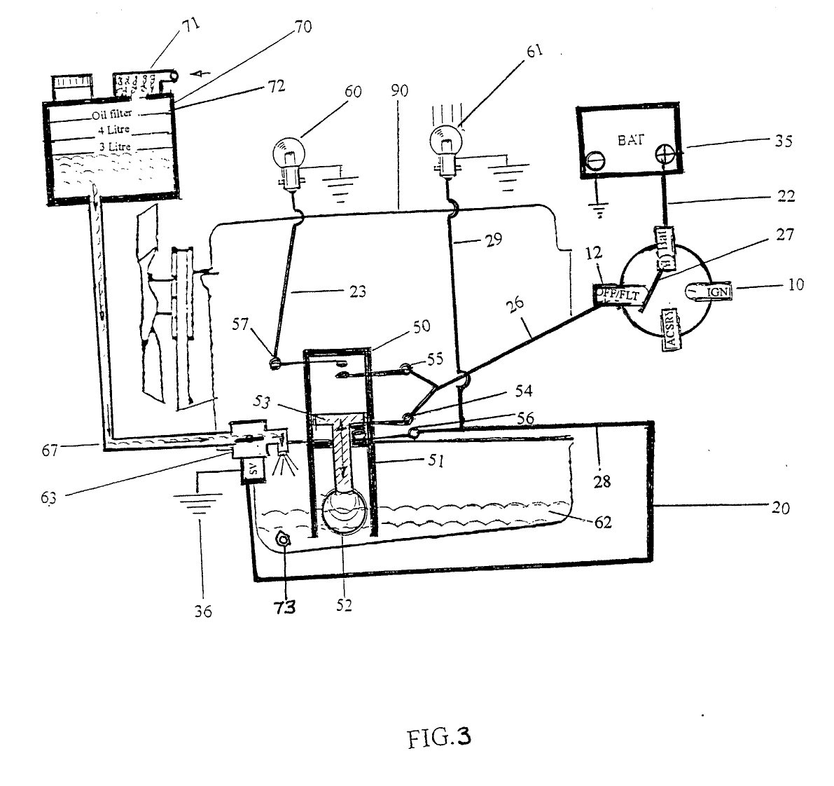

FIG. 3 illustrates a schematic of the oil level monitor, onboard oil refill tank, oil level signal lights, and automatic refill when oil level is low. As seen in FIG. 3, the battery 35 provides electric current through wire 22 to ignition switch 10, and to off/float terminal 12 through electric contact 27. The current then passes via wire 26 to the two electrical contact points 54, 55 in the float switch assembly 50, which is located in the crankcase 62. In this embodiment of the invention, there is no push button and oil “top-up” is automatic. The current passes through electric wire 20 to the solenoid valve 63. The solenoid valve 63 is normally closed. However, when the solenoid valve 63 is activated by electric current passing through wire 20, it opens and engine oil from engine oil reservoir 70 flows down through oil hose 67, through the solenoid valve 63 and into the crankcase 62 of the engine 90. As the level of engine oil in the crankcase builds up, the float 52 ascends so that the plate 53 no longer contacts the lower movable electric contact point 54. This breaks the circuit and the solenoid valve 63 shuts off.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An oil level indicator and oil refill device comprising:
(a) a source of electrical power;
(b) an engine crankcase;
(c) an oil level float in the crankcase;
(d) a first electrical contact point associated with the oil level float;
(e) a second electrical contact point located at a predetermined level in the crankcase;
(f) an oil reservoir; and
(g) an electrical solenoid valve connected to the source of electrical power and the oil reservoir and normally in a closed position, the solenoid valve being activated when the first electrical contact point contacts the second electrical contact point and opening the solenoid valve and permitting oil to drain from the oil reservoir to the crankcase, said solenoid valve closing when the first electrical contact point rises with oil level and ceases to contact the second electrical contact point.

2. A device as claimed in claim 1 wherein the float in a lower position causes the first electrical contact point to contact the second electrical contact point and permit electrical current from the source of electrical power to activate a red light.

3. A device as claimed in claim 2 wherein the first electrical contact point is connected to the source of electrical power by an ignition switch.

4. A device as claimed in claim 1 wherein the float is constructed of a housing which is open to oil level in the crankcase and an oil float within the housing that rides at the level of the oil in the crankcase.

5. A device as claimed in claim 1 wherein the oil reservoir is equipped with an air cleaner and is marked with markings which indicate the amount of oil that has been added to the crankcase to bring the level of oil in the crankcase to a predetermined level.

6. A device as claimed in claim 2 including a control button which when depressed, causes the first electrical contact point to contact the second electrical contact point and enable electrical current to pass from the source of electrical power to the solenoid valve to open the solenoid valve.

7. An oil level indicator and oil refill device comprising:
(a) a source of electrical power;
(b) an engine crankcase;
(c) an oil level float in the crankcase;
(d) an upper electrical contact point;
(e) a lower electrical contact point;
(f) an oil reservoir;
(g) an electrical solenoid valve connected to the source of electrical power and the oil reservoir; and
(h) a control button which is connected to the solenoid valve and when activated opens the solenoid valve and permits oil to drain from the oil reservoir to the crankcase.

8. A device as claimed in claim 7 wherein the float in an upper position causes a movable contact point to contact an upper stationary contact point to permit electrical current from the source of electrical power to activate a green light.

9. A device as claimed in claim 8 wherein the float in a lower position causes a movable contact point to contact a lower stationary contact point to permit electrical current from the source of electrical power to activate a red light.

10. A device as claimed in claim 9 wherein the movable upper and lower contact points are connected to the source of electrical power by an ignition switch.

11. A device as claimed in claim 7 wherein the float is constructed of a housing which is open to oil level in the crankcase and an oil float within the housing that rides at the level of the oil in the crankcase.

12. A device as claimed in claim 7 wherein the oil reservoir is equipped with an air cleaner and is marked with markings which indicate the amount of oil that should be added to the crankcase to bring the level of oil in the crankcase to a predetermined level.

13. A device as claimed in claim 7 wherein the control button when depressed, contacts a terminal which enables electrical current to pass from the source of electrical power to the solenoid valve and opens the solenoid valve.

14. An oil level indicator and oil refill device comprising:
(a) a source of electrical power;
(b) an engine crankcase;
(c) an oil level float in the crankcase;
(d) a first electrical contact point associated with the oil level float;
(e) a second electrical contact point located at a predetermined level in the crankcase;
(f) an oil reservoir;
(g) an electrical solenoid valve connected to the source of electrical power and the oil reservoir and normally in a closed position, the solenoid valve being activated when the first electrical contact point contacts the second electrical contact point and opening the solenoid valve and permitting oil to drain from the oil reservoir to the crankcase, said solenoid valve closing when the first electrical contact point rises with oil level and ceases to contact the second electrical contact point;
wherein the float in a lower position causes the first electrical contact point to contact the second electrical contact point and permit electrical current from the source of electrical power to activate a red light;
wherein the first electrical contact point is connected to the source of electrical power by an ignition switch; and
wherein the float is constructed of a housing which is open to oil level in the crankcase and an oil float within the housing that rides at the level of the oil in the crankcase.

15. A device as claimed in claim 14 including a control button which when depressed, causes the first electrical contact point to contact the second electrical contact point and enable electrical current to pass from the source of electrical power to the solenoid valve to open the solenoid valve.
